(19) United States
(12) Patent Application Publication
(10) Pub. No.: US 2008/0016711 A1
(43) Pub. Date: Jan. 24, 2008

(54) Stylus with integrated RFID chip

(75) Inventor: Jean Baebler, Fribourg (CH)

Correspondence Address: DAVIDSON, DAVIDSON & KAPPEL, LLC, 485 SEVENTH AVENUE, 14TH FLOOR, NEW YORK, NY, 10018, US

(73) Assignee: Saphirwerk Industrieprodukte AG, Bruegg (CH)

(21) Appl. No.: 11/827,821

(22) Filed: Jul. 13, 2007

(30) Foreign Application Priority Data
Jul. 19, 2006 (DE) DE102006033443.4

(51) Int. Cl. G01B 7/00

(52) U.S. Cl. 33/559; 235/492; 73/1.81; 73/104

(57) ABSTRACT

A stylus includes a stem with a first end and a second end, wherein the stem includes a contact element at the first end and can be arranged with the second end in a holder, and wherein the stylus includes an RFID chip. Also, a measurement device including the stylus and a method for taking account of data characterizing the stylus in a measurement device is provided.

This claims the benefit of German Patent Application No. 10 2006 033 443.4, filed on Jul. 19, 2006, and hereby incorporated by reference herein.

The present invention relates generally to a stylus.

### BACKGROUND

Manufacturing and measurement procedures are increasingly automated today on economic grounds.

Special measurement procedures which use special styli need the bending characteristics or distortion of these styli, obtainable from manufacturer-specific characteristic data or error data. Such error data are today mostly integrated manually when evaluating measurement procedures. Such a procedure is time- and cost-intensive when a large number of measurements are involved.

A method for measuring the bending characteristics or distortion data of styli by means of a calibrating device has already been described in detail in EP 1248073 B1.

### SUMMARY OF THE INVENTION

It is an object of the present invention to make available a measurement device and method which make it possible to automate measurement procedures and make them more profitable.

The present invention provides a stylus with integrated RFID chip.

According to a first feature of the present invention a stylus is provided which has a stem with a first end and with a second end, wherein the stem includes a contact element at the first end and can be arranged with the second end in a holder, and wherein the stylus includes an RFID chip.

A stylus is preferably part of a measurement device and has dimensions and material properties which meet the criteria for such measurement devices. The stylus preferably has the form of a cylinder which has at a first end a taper or handle which in turn preferably has the form of a cylinder. At a second end, which is furthest from the first end, the stylus preferably has the form of a frustum.

The holder for housing the stylus is preferably made of steel, titanium etc. The stem of the stylus, i.e. the middle part of the stylus, is preferably made of hard metal, ceramic (used as an umbrella term to include nitrides, oxides, carbides, borides, ferrites, silicides and their compounds in polycrystalline and monocrystalline structure), fibre-reinforced plastic, etc.

At the first end of the stylus a contact element may be attached which preferably has the form of a sphere (used as an umbrella term to include a blind hole sphere, half-sphere or full sphere). The sphere is preferably made of hard metal, ceramic (used as an umbrella term to include nitrides, oxides, carbides, borides, ferrites, silicides and their compounds in polycrystalline and monocrystalline structure) or diamond. The geometry of a sphere is also suitable preferably for the measurement device proposed according to the invention. The contact element comes into contact with the item or object to be examined or measured later during the measurement procedure. The force-related bending curves and geometric data are known from the contact element and the stylus, i.e. the data characterizing the stylus which give the error deviations to be taken into account during the measurements.

The data characterizing the stylus, such as for example bending curves and geometric data, may be defined in a measurement method by means of a calibrating device, such as has been represented for example in an earlier application (EP 1248073 B1) of the applicant.

Additionally the stylus may be embedded with the contact element in a sensor head or a holding device. The stylus can preferably be pushed, screwed, glued or otherwise locked into the sensor head or the holding device. It is thereby guaranteed that a solid and stable connection which is responsible for the quality and accuracy of the measurement device results between the holding device and the stylus.

By an RFID chip (radio frequency identification chip) is meant a chip which makes it possible to be able to read and store data on a transponder in contact-less fashion and without sight contact. This transponder can be attached to objects which then can be automatically and quickly identified and located with the help of the data stored on same.

For an RFID system which includes an RFID chip, wherein the chip is housed in an RFID marker, chip, tag, label or radio marker, a send-receive unit (also called reader) is also required, and a computer, for example a PC or server.

The data characterizing the stylus, i.e. the bending curves and geometric data, or else also the details about the material of the stem, of the sphere, geometric data, such as length of the stem, diameter of the sphere, roughness of the sphere, etc. can be stored on the RFID chip using a writing device.

In a later step according to the invention these data are read by a read-out device of a measurement device which includes the stylus according to the invention and taken into account in the respective measurements. A costly manual input of the data characterizing the stylus is thus no longer necessary, as the data characterizing the stylus are automatically read via the read-out device of the measurement device.

According to a further feature of the present invention it is preferred that the RFID chip is attached to or in the holder of the stylus.

The RFID chip is preferably attached to the stylus such that the RFID chip is embedded in a recess of the stylus. It is likewise conceivable that the RFID chip is let into the stylus or is glued to the stylus as a type of marker. The advantage thereby results that the RFID chip is firmly connected to the stylus and it is guaranteed that the RFID chip cannot be released from the stylus and become lost and thus there can be no confusions during the measurements.

According to a further feature of the present invention it is preferred that the RFID chip is attached to the second end of the stem of the stylus. The second end is the end of the stylus which can be pushed, screwed or glued into the holding device of the measurement device with the holder. As this end of the stylus is furthest from the contact element it is guaranteed that during a measurement procedure this end of the stylus is less error-prone when reading an RFID chip.

According to a further feature of the present invention it is preferred that data characterizing the stylus, i.e. force-related bending curves and geometric data, are or can be stored on the RFID chip. Such data can preferably be bending characteristics data. By such data are meant preferably those data which provide information about the error value of a stylus on the basis of deformations during measurements by applying a force F. The measured bending curve is stored on the RFID chip by means of a calibrating device. These force-related bending curves and geometric data are taken into account later when evaluating the measurements in order to obtain the actual measurement data and thus to be able to reduce the measurement uncertainty.

According to a further feature of the present invention it is preferred that geometric data of the stylus can be stored on the RFID chip. By force-related bending curves are meant preferably those data which provide information about the error value of a stylus on the basis of deformations during the measurements by applying a force F. The measured force-related bending curve is stored on the RFID chip in the form of a maximum error in relation to the force.

The present invention further provides a measurement device which includes a stylus according to the previous claims, wherein by using a wireless connection to a measurement apparatus bending characteristics data can be read from the RFID chip.

By a measurement device is preferably meant a device for establishing longitudinal or vertical deviations or dimensions of a measurement object.

According to a further feature of the present invention it is preferred that by using a wireless connection the force-related bending curves and geometric data can be read from the RFID chip by a measurement apparatus. A measurement apparatus preferably has a send-receive unit (also called reader) in order to be able to read data from the RFID chip.

According to a further feature of the present invention it is preferably that the contact element is a sphere. It is preferred that the sphere is firmly attached to the stylus by means of adhesive, a soldering process or compression joint, etc. The form of a sphere is preferred, as manufacturer-specific data are available for this and the spherical shape has proved advantageous in measurements.

The present invention also provides a method for taking into account bending characteristics data of a measurement device with a stylus according to the invention, wherein the method comprises the steps:
a. Reading the data characterizing the stylus from the RFID chip,
b. Transmitting the data characterizing the stylus to a computer,
c. Taking account of the data characterizing the stylus when evaluating measurement data by the computer.

By the step of reading data characterizing the stylus, wherein these data are preferably force-related bending curves and geometric data from an RFID chip attached to the stylus, is meant the force-related bending curves and geometric data which are stored on the RFID chip, wherein these are read by a suitable device, preferably a measurement apparatus which has a corresponding send-receive unit (reader). By using suitable radio frequency signals the measurement apparatus creates a wireless communication connection with the RFID chip and can then read the force-related bending curves and geometric data preferably of the stylus and contact element from the RFID chip.

By the step of transmitting the force-related bending curves and geometric data to a computer is meant preferably that the force-related bending curves and geometric data of the stylus are transferred wirelessly or via a data cable or data connection to a computer, preferably a PC or a server, which evaluates the measurement data. Such a computer is preferably a processor which manages or controls a management or control function of the corresponding measurement devices.

By the step of taking account of the force-related bending curves and geometric data when evaluating the measurement data by the computer is meant preferably that when evaluating the measurement data the force-related bending curves and geometric data of the stylus stored on the RFID are taken into account when evaluating the measurement results by a PC connected to the measurement apparatus, i.e. that the corresponding error values of the stylus are taken into account when evaluating the measurement data.

According to a further feature of the present invention it is preferred that the force-related bending curves and geometric data are read by a measurement apparatus. As already mentioned previously this measurement apparatus preferably has a send-receive unit via which the force-related bending curves and geometric data stored on the RFID chip can be read.

It is also preferred that a measurement device has a plurality of holding devices, wherein a stylus with integrated RFID chip is inserted into each individual holding device and a contact element, as described previously, is attached to this. According to the method according to the invention it is preferred that the force-related bending curves and geometric data of each individual stylus be transmitted to a measurement apparatus of the overall measurement system, evaluated by a PC and taken into account in the respective measurement results.

Preferred embodiments of the invention are explained in more detail below with reference to the drawing.

### BRIEF DESCRIPTION OF THE DRAWINGS

FIG. 1 shows a top view of the stylus according to the invention with integrated RFID chip.

FIG. 2 shows a plurality of measurement devices with integrated RFID chip.

### DETAILED DESCRIPTION

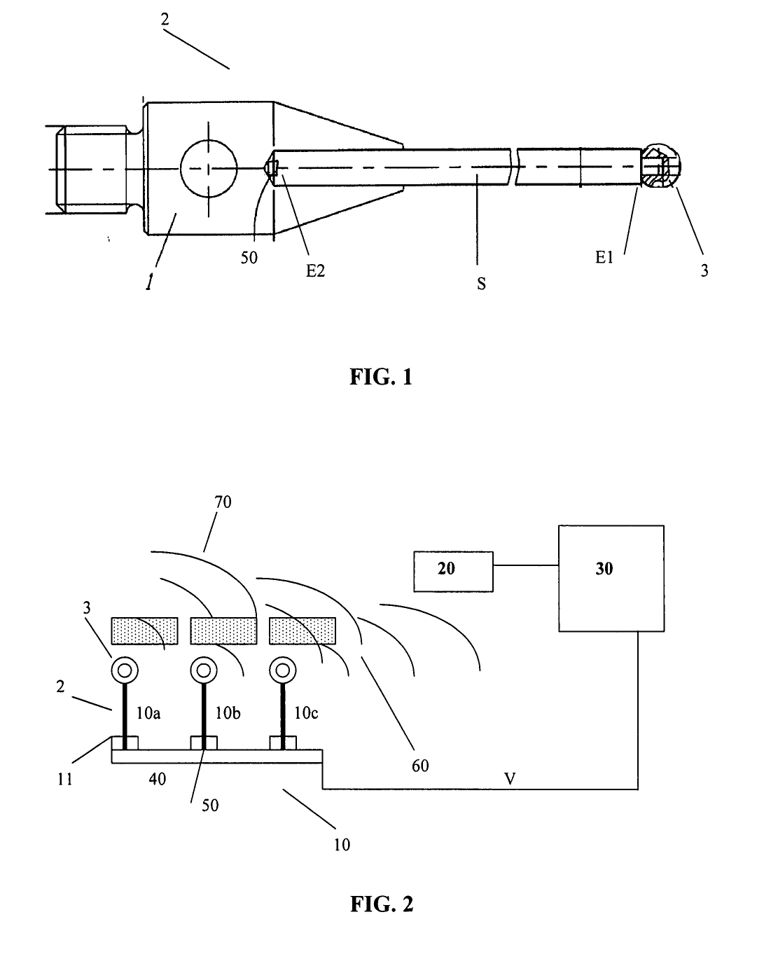

In FIG. 1a top view of the stylus 2 according to the invention with an integrated RFID chip is shown.

The stylus 2 has a stem S with a first end E1 and a second end E2. The geometry of the stem (S) of the stylus 2 corresponds to a cylinder, wherein its first end E1 has a tapered cylindrical end, onto which is glued as contact element a sphere 3 which is brought into contact with the measured object during a measurement procedure.

The second end E2 of the stylus 2 has a frustum-shaped form which at its end into which the RFID chip 50 according to the invention is glued has a recess in the form of a bore.

The stylus 2 is introduced with its second end E2 into a holder 1, which has a cylindrical recess. The connection between the stem S of the stylus and the holding device 1 can be carried out by adhesive, a soldering process, a shrink fit or a press fit etc. or their combinations. The connection between the stylus 2 and the holding device or the sensor head 1 is a screwed connection.

The stylus has the following parameters in this example: the holder 1 is made of steel according to DIN 1.4305, the stem S of the stylus 2 is made of hard metal and the sphere 3 consists of ruby.

The overall length of stylus, contact element and holding device is 30.5 mm in this example.

The sphere of the contact element has a roughness of 0.02 μm.

Three measurement devices 10a, 10b and 10c are shown in FIG. 2 which have a stylus 2 with a holder 1 and a contact element 3 as has already been described in FIG. 1. The respective styli 2 are screwed into the holding devices or sensor heads 11 of the measurement devices 10a to 10c.

Also in FIG. 2 a measurement device actuator 40 is shown which activates the measurement devices 10a-10c in order to come into contact with the measured object 60, and a measurement apparatus 20 and a PC 30.

The method for taking into account data characterizing the stylus, in particular bending characteristics data of a measurement device, is to be explained by means of FIG. 2.

The data characterizing the stylus have already been ascertained by a method for a calibrating device which has been described in detail in EP 1248073 B1 and which will not be described in more detail here.

Firstly a user of the measurement device 10 attaches a plurality of measurement devices 10a, 10b and 10c in the respective holding device 11 of the individual measurement devices 10a-10c. The styli 2 are pushed into the respective holding devices 11 of the individual measurement devices 10a-10c.

Each measurement device 10a-10c has a contact element 3 which is made from ruby and which has characteristic data (maximum diameter deviation, maximum dimensional deviation, roughness) which have already been described in FIG. 1.

An RFID chip 50 is glued to the second end E2 of each of the styli 2 by means of a marker.

As soon as the respective styli 1 have been introduced with the respective specific RFID chips 50 into the holding devices 11 of the respective measurement devices 10a-10c, the user activates the measurement apparatus 20 by means of his computer 30.

This measurement apparatus has a send-receive unit, which creates a wireless connection between the individual RFID chips 50 of the measurement devices 10a-10c by means of radio frequency waves 70 (RFID) and which reads the bending characteristics data stored on the RFID chips 50.

The data characterizing the stylus, such as bending curves and geometric data of the styli 1 and contact elements 3 are stored on the respective RFID chips 50 of the respective individual measurement devices 10a-10c, using a measurement-evaluation program stored on the PC 30 when evaluating the measurements, in order to take account of the corresponding data characterizing the stylus when evaluating the measurement data. Diameter- and form-related deviations of the respective styli and contact elements of the measurement devices 10a-10c are stored in these data characterizing the stylus.

As soon as the measurement apparatus 20 has read the data characterizing the stylus from the respective RFID chips 50 of the measurement devices 10a-10c, these are sent to the PC 30 which takes these into account with the measurement data which it has obtained via the data connection V to the measurement devices 10a-10c. Thus if, via the data connection V, the PC has measured a measurement value of 0.5 mm in the measured object 60 and the error of the bending characteristic is +0.01 mm, the measurement-evaluation program corrects the actual value to 0.51 mm.

With the present measurement device according to the invention and the method according to the invention it is thus possible by means of the RFID chip integrated in the stylus to efficiently and simply transfer stylus and contact element-specific data of a plurality of measurement devices to a measurement apparatus connected to a PC, wherein by means of a measurement-evaluation program the PC then corrects the measured values of the measurement result taking into account the values of the bending characteristics.

What is claimed is:

1. A stylus comprising:
a stem having a first end and a second end, the stem including a contact element at the first end and arrangable with the second end in a holder; and
an RFID chip.

2. The stylus according to claim 1, wherein the RFID chip is attached to the stem.

3. The stylus according to claim 2, wherein the RFID chip is arranged in the second end of the stem.

4. The stylus according to claim 1, wherein the RFID chip stores data characterizing the stylus.

5. The stylus according to claim 1, wherein the contact element is a sphere.

6. The stylus according to claim 1, the contact element is a blind hole sphere.

7. A measurement device comprising:
a stylus according to claim 1, and
a measurement apparatus receiving bending characteristics data via a wireless connection from the RFID chip.

8. A method for taking account of bending characteristics data of the measurement device according to claim 7, wherein the method comprises the steps:
reading data characterizing the stylus from the RFID chip;
transmitting the data characterizing the stylus to a computer; and
taking into account the data characterizing the stylus when evaluating measurement data by the computer.

9. The method according to claim 8, wherein the bending characteristic data are read by the measurement apparatus.
